(19) United States
(12) Patent Application Publication
(10) Pub. No.: US 2022/0380180 A1
(43) Pub. Date: Dec. 1, 2022

(54) ELEVATOR SYSTEM WITH AIR-BEARING LINEAR MOTOR

(71) Applicant: Inventio AG, Hergiswil (CH)

(72) Inventors: Erich Bütler, Ebikon (CH); Josef Husmann, Luzern (CH); Christian Studer, Kriens (CH)

(21) Appl. No.: 17/755,935

(22) PCT Filed: Nov. 16, 2020
(86) PCT No.: PCT/EP2020/082251

§ 371 Date: May 12, 2022

(30) Foreign Application Priority Data
Nov. 19, 2019 (EP) 19210040.2

(51) Int. Cl. B66B 11/04; F16C 29/02; H02K 41/03

(52) U.S. Cl. CPC B66B 11/0407; F16C 29/025; H02K 41/031

(57) ABSTRACT

An elevator system has an elevator shaft, an elevator car and a drive device for displacing the elevator car within the elevator shaft. The drive device is a linear motor that has a stationary part secured to a shaft wall of the elevator shaft and a movable part secured to the elevator car. The drive device has an air bearing between the stationary part and the movable part that keeps the stationary part spaced apart from the movable part via an air gap therebetween.

### FIELD

The present invention relates to an elevator system and, in particular, to an elevator system using an air-bearing linear motor to move an elevator car.

### BACKGROUND

Conventionally, in an elevator system, a single elevator car is displaced up and down within an elevator shaft in order to move people or goods between different levels, for example inside a building. In particular, in elevator systems that are designed for tall buildings and/or to provide high conveying capacities, the elevator car is typically moved by means of cable- or belt-like conveying means, which in turn are displaced by a rotating traction sheave driven by an electric motor.

New elevator concepts are being developed in which multiple elevator cars are intended to be displaceable independently of one another in a common elevator shaft. Conventional drives with cables or belts cannot generally be used for these elevator concepts.

Alternative drive concepts have therefore been proposed. For example, EP 1 818 305 B1 describes an elevator system comprising an elevator car driven by a linear drive system.

### SUMMARY

Among other things, there may be a need for an elevator system with an advantageously further developed drive system. In particular, there may be a need for an elevator system in which a drive system can displace multiple elevator cars independently of one another.

A need of this kind can be met by the elevator system according to the advantageous embodiments that are defined in the following description.

According to one aspect of the invention, an elevator system is proposed which has an elevator shaft, an elevator car and a drive device for displacing the elevator car within the elevator shaft. The drive device comprises a linear motor which has a stationary part secured to a wall of the elevator shaft and a movable part secured to the elevator car. The drive device has an air bearing which is located between the stationary part and the movable part and is designed to keep the stationary part spaced apart from the movable part via an air gap therebetween.

Possible features and advantages of embodiments of the invention can be considered, inter alia and without limiting the invention, to be based upon the concepts and findings described below.

The elevator system presented here is intended to have at least one elevator shaft and at least one elevator car. As explained in more detail below, the elevator shaft can be linear, in particular vertical. However, the elevator shaft can also have branches, bends or the like and/or two elevator shafts interconnected via cross-connections can be provided. The one or preferably multiple elevator cars can be displaced within the elevator shaft, and in the case of multiple elevator cars these are preferably intended to be displaceable independently of one another. One or more linear motors can be used for this.

Linear motors are electrical drive machines which, in contrast with conventional rotating electric motors, do not indirectly apply force to an object to be linearly displaced with the aid of a rotational movement, but can directly exert a force directed linearly along a movement path on the object. The movement path can run in a straight line or as a curved path. For this purpose, a linear motor has a stationary part and a movable part which can be displaced relative to one another along the movement path. For this purpose, temporally and spatially varying magnetic fields which bring about the forces necessary for this relative displacement are generated between the stationary part and the movable part. Electromagnets, for example in the form of coils, which generate the temporally varying magnetic fields via targeted energization can be provided on one of the two parts for this purpose. Components that generate a magnetic field, in particular permanent magnets, can also be provided on the other of the two parts.

Depending on the polarity, the magnetic fields generated in each case can cause attractive or repulsive forces between the two parts of the linear motor. Part of these forces act along the movement path along which the components of the linear motor that generate the magnetic field and form the stationary part are arranged. However, another part of these forces acts transversely to this movement path such that the movable part of the linear motor is pulled toward the stationary part. In general, a suitable bearing and/or lubrication is used to avoid direct high-friction mechanical contact between the stationary part and the movable part of the linear motor.

In the case of drive devices which use a linear motor to displace an elevator car in an elevator system, the movable part of the linear motor secured to the elevator car moves relative to the stationary part secured to the wall of the elevator shaft. The movable part of the linear motor can be fastened or operatively connected to the elevator car or to a frame that supports it. The stationary part of the linear motor can be fastened directly to the elevator shaft wall or to another component of the elevator system, such as a guide rail, which is attached directly or indirectly to the elevator shaft wall.

Conventionally, mechanical bearings such as roller bearings are used between the two parts of the linear motor in order to minimize the occurrence of excessive friction and wear that may be caused as a result when the two parts move relative to one another. In particular, such bearings are intended be able to withstand the attractive force that acts in the linear motor due to the magnetic fields between the stationary part and the movable part generated during its operation.

However, such mechanical bearings are generally subject to a certain amount of wear themselves. Furthermore, mechanical bearings tend to generate noise, which can be disruptive or unsettling for passengers, especially in elevator systems. In addition, mechanical bearings are usually designed specifically for particular directions of relative movement, but do not readily allow other directions of relative movement, so that a bearing arrangement of bearing partners that are to be displaceable relative to one another in different directions can often not be realized with conventional mechanical bearings, or only with great effort.

It is now proposed to use so-called air bearings between the stationary part and the movable part of the linear motor in a drive device of an elevator system instead of or, if appropriate, in addition to such mechanical roller bearings.

An air bearing can be understood to mean a bearing in which bearing partners that are movable relative to one another are separated from one another by a thin air film. The air film can prevent the two bearing partners from coming into direct mechanical contact with one another. The air film can thus be viewed as a pressure cushion that keeps the two bearing partners at a distance, counter to any other forces. Air bearings can thus also be regarded as plain bearings in which the air, which is pressed into an air gap between opposing surfaces of two bearing partners that are to be moved relative to one another, serves as a lubricating medium.

Accordingly, friction and/or stick-slip effects between the two bearing partners can advantageously be largely avoided or at least minimized.

In addition, the air film generated in the air bearing keeps the two bearing partners at a distance without generally restricting directions of movement of the two bearing partners relative to one another in different directions along the plane in which the air film is created. Accordingly, the two bearing partners can typically be made to move in any direction along a plane that extends in parallel with the interface between the two bearing partners.

Since only air is used as a lubricant, there is generally no significant contamination in the air bearing. Due to the lack of mechanical friction, there is no abrasion between the bearing partners. Accordingly, the air bearing does not usually need to be cleaned and can in the best case be maintenance-free.

In this context, the term “air” can be understood broadly and generally as being representative of gases, since it is mainly the physical properties of the gaseous medium that are relevant here and the chemical composition of the gas is generally not important for the effect in the air bearing.

According to one embodiment, the air bearing is designed as an aerostatic air bearing and is equipped for this purpose with an air supply which presses pressurized air into the air gap between the stationary part and the movable part.

In this context, an aerostatic air bearing can be understood to mean an air bearing in which, even in a stationary state in which the two bearing partners do not move relative to one another, a compressed air cushion is generated between the bearing partners which spaces the partners apart.

For this purpose, the air bearing generally has a compressed air supply which presses pressurized air against the interface between the stationary and the movable part of the linear motor and thereby creates the air gap between these parts. The compressed air supply can have a compressor, for example. In addition, the compressed air supply can have a compressed air store or a compressed air reservoir. Furthermore, the compressed air supply can have one or more nozzles, for example, which open into the air gap. The nozzles can be supplied with pressurized air from the compressor and/or the compressed air reservoir. Channels adjacent to the air gap can direct the supplied compressed air laterally along the surfaces delimiting the air gap.

For the application described herein, the air can be pressed into the air gap for example at a pressure of between 2,000 hPa (2 bar) and 10,000 hPa (10 bar), preferably between 3,000 hPa and 6,000 hPa. Such pressures can generally be sufficient for keeping the movable part and the stationary part of the linear motor at a sufficient distance from one another, counter to the forces that are generated as attractive forces between the movable part and the stationary part during operation of the linear motor due to the magnetic fields generated in the process.

According to one embodiment, the air bearing can be designed in particular to create the air gap with a gap width of less than 0.1 mm.

In other words, air pressures acting in the air bearing, configurations of nozzles that guide the air into the air gap to be created, and/or other properties of the air bearing that influence the formation of the air gap to be created can be designed in such a way that the air gap brought about between the two parts of the linear motor forms a gap width of less than 0.1 mm, preferably less than 50 μm, particularly preferably between 1 μm and 20 μm or more preferably between 2 μm and 10 μm. The air bearing can also be designed to form the air gap with a homogeneous gap width, i.e. the gap width should vary along the extension of the air gap by as little as possible, for example less than 30%, preferably less than 10%.

On the one hand, such an air gap can create a sufficient distance between the parts of the linear motor that move relative to one another in order to ensure sufficient air lubrication and thus minimal friction. On the other hand, a relatively small air flow is sufficient to form such a narrow air gap, as a result of which the requirements for the amounts of air to be compressed and fed into the air gap can be kept within acceptable limits.

According to one embodiment, the stationary part of the linear motor can be held so as to be flexibly displaceable on the shaft wall in a direction orthogonal to its surface facing the movable part and/or the movable part of the linear motor can be held so as to be flexibly displaceable on the elevator car in a direction orthogonal to its surface facing the stationary part.

In other words, the stationary part of the linear motor and/or the movable part of the linear motor can preferably not be completely rigidly secured to the shaft wall or the elevator car. Instead, it can be advantageous to couple these parts of the linear motor to the shaft wall or the elevator car such that they can be flexibly displaced at least to a small extent. The flexible connection is intended to be designed in such a way that the relevant part of the linear motor can be displaced at least slightly and resiliently relative to the elevator component to which it is to be secured in the direction directed toward the other part of the linear motor.

Such a displaceability of the two parts of the linear motor relative to one another, allows, among other things, the air gap formed between these parts to vary at least slightly with regard to its gap width. For example, the displaceability is intended to be designed in such a way that the gap width of the air gap can vary by at least 20%, preferably at least 50% or even at least 100%. In other words, the mechanical connection of the stationary part to the elevator shaft wall and/or of the displaceable part to the car can be designed in such a way that the relevant part can be resiliently displaced by up to 50 μm or at least up to 20 μm toward the elevator shaft wall or the car.

The at least slightly flexible connection of parts of the linear motor to the components of the elevator system that are to be moved by it relative to one another can, for example, compensate for unevenness that can occur on a surface of the stationary part of the linear motor that is as smooth as possible and is directed toward the air gap. In other words, unevenness in the path of movement of the linear motor can be at least partially compensated for.

According to one embodiment, the stationary part comprises active electromagnets that can be energized, whereas the movable part of the linear motor comprises passive permanent magnets.

In other words, the part of the linear motor with which magnetic fields are to be generated in a temporally variable manner is to be formed by the stationary part secured to the wall of the elevator shaft. For this purpose, the stationary part can have electromagnets in which a magnetic field can be generated with the aid of an electric current passed through a coil. A polarity and a strength of the magnetic field can be influenced depending on a direction and a current intensity of the current, as a result of which this part can also be referred to as the active part of the linear motor.

In contrast, only static magnetic fields can be generated in the passive part of the linear motor, for example by means of permanent magnets provided there. It is preferable to form the passive part of the linear motor using the movable part secured to the elevator car. Accordingly, a power supply does not need to be provided for this movable part, and so there is no need in particular for complex wiring of the elevator car.

According to one embodiment, the elevator car can be designed with a backpack construction and the movable part of the linear motor can be arranged on the rear side of the backpack construction.

In the case of an elevator car designed with a backpack construction, the elevator car is held on only one side. Typically, the elevator car is held by a frame that holds the elevator car from a rear side. The rear side is generally opposite a front side of the elevator car, on which for example a car door is provided through which passengers can get in and out. The frame supports the elevator car and is used to transmit a force exerted by the drive device to the elevator car. In conventional elevators, in a backpack construction the supporting cables or supporting straps regularly engage with a frame part located behind the elevator car.

Similarly, in the elevator system described herein, the drive device is intended to exert the forces necessary for displacing the elevator car in a rear region on or adjacent to the elevator car, in particular on a frame part located there. Since the drive device in this case is formed by one or more linear motors, this means that the movable part of such a linear motor is attached to the rear part of the elevator car, i.e. in particular to the frame part located there. The elevator car in this case is supported on one side only, so that the attractive forces brought about by the magnets, as generated in the linear motor, prevent the elevator car from tipping and falling away from the movement path. Overall, this allows a particularly simple construction for the elevator system.

According to one embodiment, the elevator system has multiple elevator cars that are to be displaced within the same elevator shaft.

In other words, multiple elevator cars can be displaced within a common elevator shaft. Each elevator car can preferably be displaced independently of the other elevator cars. Each individual elevator car can have a linear motor assigned to it which can be actuated in order to be able to displace this elevator car individually.

It is not absolutely necessary for each linear motor of each elevator car to have its own stationary part and its own movable part. Instead, a stationary part to be shared may be secured in the elevator shaft. Electromagnets in this stationary part can be energized individually, and so the entire stationary part can be considered as being divided into segments. Accordingly, coils in one or some of the segments can be suitably energized in a targeted manner in order to allow one of the elevators cars adjacent to this segment to be individually displaced by interaction with its movable part of the linear motor.

According to one embodiment, the elevator shaft can have vertical regions and non-vertical regions.

For example, the elevator shaft can have a vertical region that interconnects different floors within a building. One or more non-vertical regions, in particular horizontal regions, can proceed from this vertical region. In this case, elevator cars can be displaced along the vertical region in order to transport people between the floors. If conflict situations arise between different elevator cars, for example if one car has to overtake another car or if oncoming cars have to avoid each other, one of the cars can be moved to a nearby non-vertical region, i.e. it can essentially avoid the other car for a short time. Optionally, two separate vertical regions can also form an elevator shaft to be used jointly, so that for example elevator cars moving upward are always moved in one shaft and can reach the other shaft via one of the non-vertical regions in order to be able to travel downward again.

For such a design of an elevator system, it can be advantageous on the one hand to design the drive device with its linear motors in such a way that the elevator cars can be displaced in the vertical as well as in the non-vertical direction. On the other hand, a bearing and/or a guide that supports or guides the elevator car during its various displacements is also intended to allow the displacement movements of the elevator car in the different directions.

For this purpose, according to one embodiment, the drive device can have a linear motor, which is also referred to hereinafter as a vertical linear motor, of which the elongate stationary part extends vertically and which is designed to displace the elevator car vertically.

In other words, the vertical linear motor is designed to displace the elevator car along a vertical movement path. For this purpose, the vertical linear motor can have a large number of individually energizable electromagnets which are arranged at least substantially vertically one above the other along the movement path. A single elevator car or each of a plurality of elevator cars can thus be individually displaced up and down within the elevator shaft with the aid of the vertical linear motor.

Alternatively or preferably in addition, according to one embodiment the drive device can have a linear motor, which is also referred to hereinafter as a horizontal linear motor, of which the elongate stationary part extends horizontally and which is designed to displace the elevator car horizontally.

The horizontal linear motor thus allows the elevator car to be displaced along a horizontal movement path or a movement path which is not completely vertical but has at least a horizontal component. The term “horizontal” in this context can be interpreted broadly as being transverse to a vertical direction, preferably perpendicular to a vertical direction. For this purpose, the horizontal linear motor can have a large number of individually energizable electromagnets which are arranged at least substantially horizontally next to one another along the movement path. Electromagnets of such a horizontal linear motor are arranged so as to be spaced apart next to one another horizontally. With the aid of such a horizontal linear motor, an elevator car can thus be displaced from the vertical into a horizontally branching sub-region of the elevator shaft, for example.

According to one embodiment, the drive device can have an additional linear motor which is designed and arranged to bring about a force on the elevator car that counteracts a tilting moment acting on the elevator car.

The additional linear motor can be constructed similarly to the vertical linear motor or the horizontal linear motor and/or can be actuated independently of these linear motors. The additional linear motor can preferably be arranged in the same plane as the vertical linear motor and/or the horizontal linear motor described above. The additional linear motor can be arranged so as to be laterally spaced apart from the vertical linear motor or the horizontal linear motor.

According to a specific embodiment, the additional linear motor can be designed as a second vertical linear motor which is designed, at a lateral distance, for example parallel to the first vertical linear motor, to bring about a vertical displacement movement for the same elevator car.

An additional force can be applied to the elevator car with the aid of the additional linear motor. Due to the spacing between the additional linear motor and the vertical linear motor or the horizontal linear motor, a torque can be generated on the elevator car. Such a torque can act about an axis which is orthogonal to the air gap in the linear motor. This torque can be set in such a way that it counteracts a tilting moment acting on the elevator car. Such a tilting moment can act on the elevator car for example if one or more people inside the elevator car are not located substantially in the center of the elevator car, but away from its center of gravity. Such a tilting moment can thus be largely compensated for by suitably actuating the additional linear motor.

According to one embodiment, the drive device can have a brake coating adjacent to the air gap.

In other words, a special brake coating can be provided, for example, on a surface of the stationary part of the linear motor that faces the air gap and/or on an opposite surface of the movable part of the linear motor that faces the air gap. This brake coating can exhibit for example increased friction between the opposing surfaces when they come into mechanical contact than would be the case without such a brake coating. For example, such a brake coating can consist of a plastic, in particular a polymer or elastomer.

The provision of such a brake coating can be particularly advantageous when, according to one embodiment, the air bearing can be activated and deactivated in a controllable manner.

In this case, the drive device can also be used as a braking device. As long as the air bearing is activated, the stationary part and the movable part of the linear motor are spaced apart by the air gap generated therebetween. However, the generation of the air gap can be temporarily interrupted by deactivating the air bearing, for example by temporarily closing a compressed air supply using controllable valves. As soon as the air bearing is deactivated, the opposing surfaces of both parts of the linear motor come into mechanical contact and are pressed against one another, driven by the magnetic forces generated in the linear motor and acting attractively between the two parts of the linear motor. On the one hand, the brake coating can cause increased friction between the parts of the linear motor that move relative to one another along the movement path. On the other hand, the brake coating can be designed or act in such a way that damage to the parts of the linear motor due to the friction generated and/or the resulting heat can be prevented.

In particular if multiple elevator cars are to be displaceable independently of one another in the elevator system, it can be advantageous according to one embodiment to design the air bearing with a large number of air bearing segments which are arranged one behind the other along a movement path of the elevator car, with the air bearing segments being able to be activated and deactivated in an individually controllable manner.

In other words, it can be advantageous not to design the air bearing as a unitary component which extends over long distances within the elevator shaft, i.e. for example vertically from near a shaft floor to near a shaft ceiling, and of which the function can be controlled only over its entire extension length. Instead, the air bearing can be composed of multiple air bearing segments which can be activated and deactivated individually. The air bearing segments can be arranged adjacent to each other along the desired movement path of the elevator car so that, with suitable actuation of the air bearing segments, the displaceable part of the linear motor can always be spaced apart from the adjacent stationary part of the linear motor by an air gap that is generated by the locally adjacent air bearing segments. In other words, the bearing effected by the air bearing can be brought about in each case by targeted actuation of the local air bearing segments at the current location of the elevator car. This can make the air bearing more efficient, since air losses can be avoided at positions of the air bearing that are not required.

In particular, if multiple elevator cars are to be displaced independently of one another, the possibility of being able to actuate the air bearing segments independently of one another can also be used to generate a braking effect in a targeted manner for one of the elevator cars by locally deactivating individual air bearing segments. For this purpose, the air bearing segments that are adjacent to a current position of the elevator car to be braked can be temporarily deactivated in a targeted manner so that the movable part of the linear motor of this elevator car comes into contact with the stationary part and the resulting friction leads to the desired braking effect on the elevator car.

It should be understood that some of the possible features and advantages of the invention are described herein with reference to different embodiments of the elevator system, and in particular of the linear motor used therein and the air bearing used therein. A person skilled in the art will recognize that the features may be combined, adapted, or exchanged as appropriate in order to arrive at further embodiments of the invention.

In the following, embodiments of the invention will be described with reference to the accompanying drawings; neither the drawings nor the description should be considered as limiting the invention.

### DESCRIPTION OF THE DRAWINGS

FIG. 1 is a lateral sectional view of an elevator system according to one embodiment of the present invention.

FIG. 2 is a front view of an elevator system according to one embodiment of the present invention.

The drawings are merely schematic and not to scale. Identical reference signs refer to identical or equivalent features in the various figures.

### DETAILED DESCRIPTION

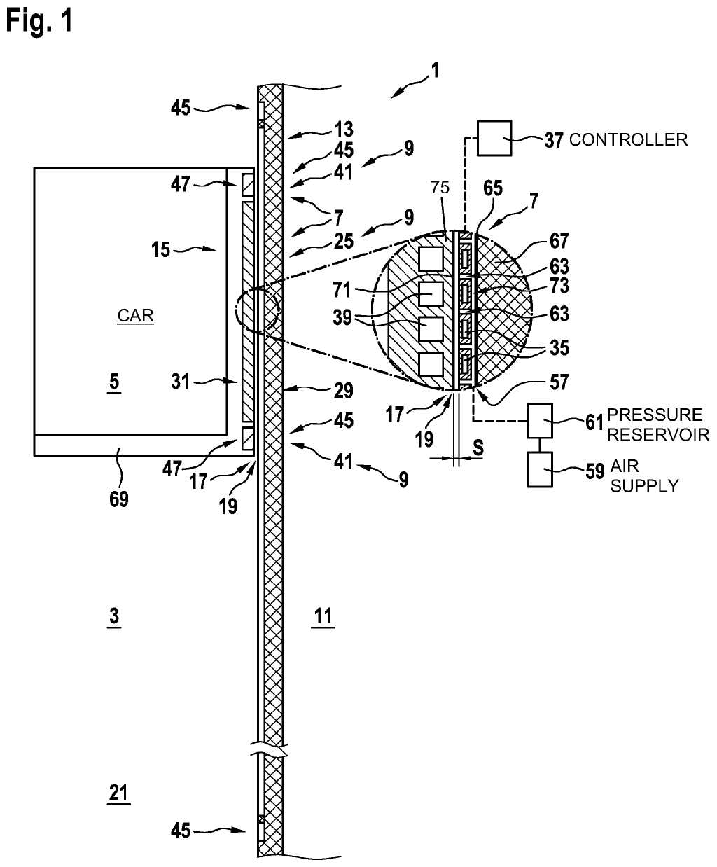

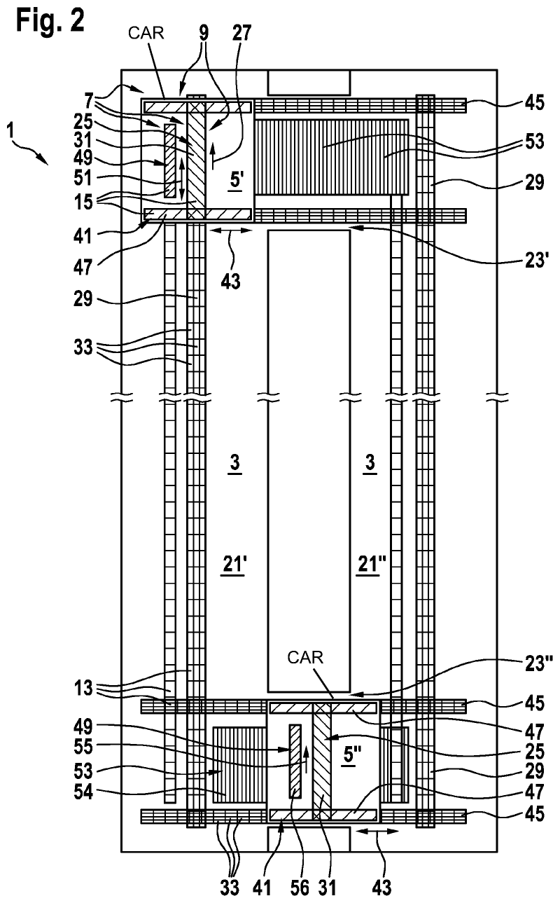

FIGS. 1 and 2 schematically show components of an elevator system 1 in a lateral and frontal sectional view respectively. The elevator system 1 has an elevator shaft 3 in which at least one elevator car 5 can be displaced in a vertical region 21. Two of the elevator 5 are shown as elevator cars 5′ and 5″ in FIG. 2. In order to be able to displace the elevator car 5, a drive device 7 is provided. The drive device 7 comprises a linear motor 9 with a stationary part 13 secured to a wall 11 of the elevator shaft 3 and a movable part 15 secured to the elevator car 5. Furthermore, the drive device has an air bearing 17 which is formed between the stationary part 13 and the movable part 15 of the linear motor 9 in order to space these two parts 13, 15 apart from one another via an air gap 19 therebetween.

In the example shown in FIG. 2, the elevator system 1 with its elevator shaft 3 has two of the vertical region 21 being vertical regions 21′, 21″ that extend in parallel with one another and are horizontally spaced apart from one another, as well as two non-vertical, in particular horizontal regions 23′, 23″ that extend in parallel with one another and are vertically spaced apart from one another. The two horizontal regions 23′, 23″ interconnect the two vertical regions 21′, 21″.

Multiple elevator cars 5′, 5″ can be displaced independently of one another in the elevator shaft 3 constructed in two parts in this way. For example, an elevator car 5′ can travel upward in one of the vertical regions 21′. Arriving at an upper end of the vertical region 21′, this elevator car 5′ can be displaced horizontally through the horizontal area 23′ there toward the other vertical region 21″. The elevator car 5′ can then be displaced downward through this vertical region 21″ in order to ultimately be able to reach its initial position in the first-mentioned vertical region 21′ again through the other horizontal region 23″ located there.

In order to be able to displace the elevator car 5 accordingly, the drive device 7 has a plurality of linear motors 9.

In particular, vertical linear motors 25 are provided to apply a force 27 directed vertically upward to the elevator car 5. This force 27 can overcompensate for a weight of the elevator car 5 so that the elevator car 5 can be moved upward.

In the examples shown, components for a vertical linear motor 25 are provided in each of the two vertical regions 21 (21′, 21″) of the elevator shaft 3, which motor extends substantially along the entire length of the vertical region 21 and is thus designed for a displacement of the elevator car 5 along a movement path that extends over the entire length of the vertical region 21.

The vertical linear motor 25 has a stationary part 29 attached to the wall 11 of the elevator shaft 3 and a movable part 31 attached to the elevator car 5. In the example shown, the stationary part 29 is designed as an active part of the vertical linear motor 25 in order to generate temporally and/or spatially varying magnetic fields. For this purpose, the stationary part 29 is divided into a large number of linear motor segments 33 (see FIG. 2). The linear motor segments 33 are anchored to the wall 11 of the elevator shaft 3 vertically one above the other in a linear arrangement. In each linear motor segment 33 there is an electromagnet 35 in the form of a coil that can be energized, for example. The energizing of the electromagnets 35 in the various linear motor segments 33 can be controlled in an open or closed loop for example by a controller 37 (for reasons of clarity, wiring of the linear motor segments 33 to the controller 37 has not been shown). The movable part 31 of the vertical linear motor 25 is designed as a passive part and has permanent magnets 39 for generating magnetic fields that are constant over time.

Furthermore, the drive device 7 has horizontal linear motors 41. The horizontal linear motors 41 are designed to generate temporally varying magnetic fields by means of which a horizontally directed force 43 can be exerted on the elevator cars 5. In the example shown, components of the horizontal linear motors 41 are located on each of the horizontal regions 23′, 23″ of the elevator shaft 3 in order to be able to displace the elevator cars 5′, 5″ through one of these horizontal regions 23′, 23″ in each case.

The horizontal linear motors 41 also have a stationary part 45 and a movable part 47. The stationary part 43 is in turn attached to the wall 11 of the elevator shaft 3 and designed as an active part with electromagnets 35 provided therein. The stationary part 43 extends over the entire width of the two vertical regions 21′, 21″ of the elevator shaft 3 that are arranged next to one another, including the horizontal region 23′, 23″ in between. In this case, linear motor segments 33 can be arranged horizontally next to one another. The movable part 47 is attached to the elevator car 5′, 5″ as a passive part.

In addition, the drive device 7 has additional linear motors 49 (FIG. 2). These additional linear motors 49 are designed to bring about compensating forces 51 on the elevator car 5 which counteract a tilting moment of the elevator car 5. For this purpose, the additional linear motors 49 can be arranged in such a way that the compensating forces 51 they produce act laterally at a distance from the forces 27 produced by the vertical linear motor 25, so that overall a torque is produced on the elevator car 5 which can compensate as far as possible for the tilting moments acting in the elevator car 5.

In the example shown, the additional linear motors 49 are designed as additional linear motors extending in the vertical direction and are spaced laterally apart from a relevant associated vertical linear motor 25. Together with the associated vertical linear motor 25, a pair of forces 27, 51 directed vertically upward or downward can thus be exerted on the elevator car 5 with the aid of the additional linear motor 49, between which forces a torque acting on the elevator car 5 is established which can compensate for a tilting moment occurring, for example, due to inhomogeneous loading of the elevator car 5.

Components of additional linear motors 53 are also provided on the horizontal regions 23′, 23″ of the elevator shaft 3. With the aid of stationary parts 54 arranged vertically on the wall 11 and movable parts 56 arranged vertically on the elevator car 5 of such additional linear motors 53, holding forces 55 can be generated which correspond to the weight of the elevator car 5, so that the weight of the elevator car 5 can be held by means of these additional linear motors 53 while it is moved horizontally through the horizontal regions 23′, 23″ by means of the horizontal linear motor 41.

Considerable forces are exerted on the elevator car 5 by the various linear motors 9. Not only do forces 27, 43, 51, 55 act in the vertical direction or horizontal direction in planes parallel to a movement path of the elevator car 5, but there are also forces that pull the elevator car 5 toward the stationary parts 13 of the linear motors 9. In particular, due to the magnetic fields brought about in the linear motors 9, attractive forces act between the relevant stationary part 13 and the associated movable part 15.

In order to still be able to move the stationary and movable parts 13, 15 relative to one another with little friction, the air bearing 17 with the air gap 19 is formed between them. The air bearing 17 is preferably designed as an aerostatic air bearing. For this purpose, the air bearing 17 has an air supply (FIG. 1 enlarged area) by means of which pressurized gas can be pressed into the air gap 19. For this purpose, the air supply 57 can have a compressor 59 and/or a pressure reservoir 61. Pressurized gas generated or stored there can be passed through lines (not shown for reasons of clarity) of the air supply 57 to nozzles 63, which in the example shown open into the adjacent air gap 19 at a surface of the stationary part 13 of the linear motor 9.

By adjusting different parameters such as a geometric arrangement and dimensioning of the nozzles 63 and adjusting the pressure of the supplied gas to 4,000-5,000 hPa, for example, the air bearing 17 can be designed in such a way that the air gap 19 has a gap width S in the range of 0.01-0.05 mm, for example. The air gap 19 acts as a plain bearing between the stationary part 13 and the movable part 15 of the linear motor 9.

The stationary part 13 and/or the movable part 15 can preferably be held so as to flexibly displaceable on the wall 11 or on the elevator car 5. For this purpose, a flexible sheet metal 65 can be provided for example on a rear side of a supporting structure 67 accommodating the electromagnets 35. For example, the coils forming the electromagnets 35 can be molded into the supporting structure 67 from a cured resin. A surface of such a supporting structure 67 that faces the air gap 19 can be very smooth. The supporting structure 67 of the stationary part 13 of the linear motor 9 can be held from behind by the flexible sheet metal 65 such that the entire supporting structure 67 including the electromagnet 35 can be flexibly and resiliently displaced slightly orthogonally to the movable part 15 of the linear motor 9. Inaccuracies in the arrangement of the stationary and the movable parts 13, 15 relative to one another can hereby be at least partially compensated for.

In the example shown, the car 5 of the elevator system 1 is designed with a backpack construction. The respective movable parts 15, 31, 47, 56 of the different linear motors 9, 25, 41, 49, 53 are arranged in a rear part of the elevator car 5, in particular on a frame 69 holding the elevator car 5 from behind.

In the example shown, a brake coating 71 is also provided in the drive device 7 adjacent to the air gap 19. The brake coating 71 can be provided for example on a surface of a further supporting structure 75, for example consisting of cured resin, in which the permanent magnets 39 of the movable parts 31, 47, 56 of the linear motors 9, 25, 41, 49 are accommodated. The brake coating 71 can be a layer or a component made of a polymer material or an elastomeric material, for example.

In this case, the air bearing 17 can be activated and deactivated in a locally controllable manner via the controller 37, for example. For this purpose, the air bearing 17 can be divided into a large number of air bearing segments 73 which can be supplied with compressed air in an individually controllable manner. For this purpose, for example controllable valves (not shown) can be provided in compressed air lines. The air bearing segments 73 can be arranged one above the other or next to one another along a movement path of the elevator car 5. Accordingly, if necessary, one or more of the air bearing segments 73 can be deactivated locally at the position at which an elevator car 5 is currently located. Without the air gap 19 created by the relevant air bearing segment 73, the movable part 15 presses against the stationary part 13 of the relevant linear motor 9. Because of the brake coating 71 arranged between the two parts 13, 15, a braking effect can thus be brought about on the elevator car 5 that was previously being displaced. In other words, with a suitable design and controllability of the respective air bearing segments 73, the air bearing 17 can provide an additional functionality as a braking means for braking movements of the elevator car 5 at different locations of the elevator shaft 3.

Finally, it should be noted that terms such as “comprising,” “having,” etc. do not preclude other elements or steps, and terms such as “a” or “an” do not preclude a plurality. Furthermore, it should be noted that features or steps that have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. An elevator system comprising:
an elevator shaft;
an elevator car displaceable in the elevator shaft;
a drive device for displacing the elevator car within the elevator shaft;
wherein the drive device includes a linear motor having a stationary part secured to a shaft wall of the elevator shaft and a movable part secured to the elevator car; and
wherein the drive device has an air bearing formed between the stationary part and the movable part, the air bearing keeping the stationary part spaced apart from the movable part via an air gap created therebetween.

16. The elevator system according to claim 15 wherein the air bearing is an aerostatic air bearing having an air supply that presses pressurized air into the air gap between the stationary part and the movable part.

17. The elevator system according to claim 15 wherein the air bearing creates the air gap with a gap width of less than 0.1 mm.

18. The elevator system according to claim 15 wherein the stationary part of the linear motor is flexibly displaceable on the shaft wall in a direction orthogonal to a surface of the stationary part facing the movable part and/or the movable part of the linear motor is flexibly displaceable on the elevator car in a direction orthogonal to a surface of the movable part facing the stationary part.

19. The elevator system according to claim 15 wherein the stationary part includes active electromagnets that can be energized and wherein the movable part includes passive permanent magnets.

20. The elevator system according to claim 15 wherein the elevator car has a backpack construction and the movable part of the linear motor is arranged on a rear side of the backpack construction.

21. The elevator system according to claim 15 wherein the elevator system has at least two of the elevator car and the at least two elevator cars are displaceable within the elevator shaft.

22. The elevator system according to claim 15 wherein the elevator shaft has vertical regions and non-vertical regions for displacing the elevator car.

23. The elevator system according to claim 15 wherein the linear motor is a vertical linear motor with the stationary part extending vertically for displacing the elevator car vertically.

24. The elevator system according to claim 15 wherein the linear motor is a horizontal linear motor with stationary part extending horizontally for displacing the elevator car horizontally.

25. The elevator system according to claim 15 wherein the drive device includes a horizontal linear motor having another stationary part extending horizontally and another movable part secured to the elevator car for displacing the elevator car horizontally.

26. The elevator system according to claim 15 wherein the drive device includes an additional linear motor producing a compensating force on the elevator car that counteracts a tilting moment acting on the elevator car.

27. The elevator system according to claim 15 wherein the drive device has a brake coating adjacent to the air gap.

28. The elevator system according to claim 15 including a controller for activating and deactivating the air bearing in a controllable manner.

29. The elevator system according to claim 15 wherein the air bearing has a plurality of air bearing segments arranged one behind another along a movement path of the elevator car in the elevator shaft, and wherein the air bearing segments are individually activated and deactivated in a controllable manner.
